(19) United States
(12) Patent Application Publication
(10) Pub. No.: US 2025/0354825 A1
(43) Pub. Date: Nov. 20, 2025

(54) METHODS AND SYSTEMS FOR CONSTRUCTING A LANE LINE MAP

(71) Applicant: GM GLOBAL TECHNOLOGY OPERATIONS LLC, Detroit, MI (US)

(72) Inventors: Gui CHEN, Sterling Heights, MI (US); Bo Yu, Troy, MI (US); joon Hwang, Pflugerville, TX (US); Fan Bai, Ann Arbor, MI (US)

(21) Appl. No.: 18/663,604

(22) Filed: May 14, 2024

(51) Int. Cl. G01C 21/00; G06V 20/56

(52) U.S. Cl. CPC G01C 21/3815; G01C 21/3837; G01C 21/3841; G06V 20/588

(57) ABSTRACT

A system includes a control module in communication with one or more sensors of a plurality of vehicles. The control module is configured to receive a bitmap including a plurality of pixels representing a plurality of lane lines of a roadway sensed by the one or more sensors, extract a plurality of line components of the plurality of lane lines, detect whether a junction exists in a line component of the plurality of line components, in response to detecting the junction in the line component, split the line component into two or more subcomponents, generate a plurality of line points for each of the subcomponents using a regression model, create at least one line based on the plurality of line points, and generate a map of the roadway including the at least one line. Other example systems and methods for creating maps of roadways are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to methods and systems for constructing a lane line map, and more particularly to bitmap-based methods and systems for constructing a lane line map.

A map of roadways may be created using various imaging and/or data. For example, the roadway map may be created based on aerial and/or satellite imaging. Such approaches require labeling of data. In other examples, the roadway map may be created based on received crowd-sourced data. For instance, sensor data (e.g., global positioning system (GPS) data, detected lane line data, speed data, yaw data, etc.) from vehicles may be collected and uploaded to a cloud-based system. Then, the cloud-based system can run aggregation algorithms to combine different observations from the vehicles into map content, such as lane lines.

### SUMMARY

A system for creating a map of a roadway, includes a control module in communication with one or more sensors of a plurality of vehicles. The control module is configured to receive a multi-layer probability density bitmap including a plurality of pixels representing a plurality of lane lines of the roadway sensed by the one or more sensors of the plurality of vehicles, extract a plurality of line components of the plurality of lane lines, detect whether a junction exists in a line component of the plurality of line components, in response to detecting the junction in the line component, split the line component into two or more subcomponents, generate a plurality of line points for each of the subcomponents using a regression model, create at least one line based on the plurality of line points, and generate a map of the roadway including the at least one line.

In other features, the control module is configured to identify connected components of the plurality of lane lines in the bitmap, and categorize each connected component as a line component of the plurality of line components.

In other features, the control module is configured to implement a plurality of masks to extract the plurality of line components.

In other features, the control module is configured to skeletonize each line component of the plurality of line components to generate a skeletonized image, and detect the junction based on the skeletonized image.

In other features, the control module is configured to scan, with a kernel, the skeletonized image, determine a value associated with the kernel, and compare the value to a threshold to detect the junction in the line component.

In other features, the control module is configured to remove a junction point representing the detected junction in the line component to create a plurality of vectors in response to detecting the junction in the line component.

In other features, the control module is configured to determine an angle between each pair of the plurality of vectors, and cluster one or more pairs of the plurality of vectors based on the angle and a defined threshold to split the component into the two or more subcomponents.

In other features, the regression model includes a B-spline regression model.

In other features, the control module is configured to determine a length of each of the subcomponents, and generate the plurality of line points for each of the subcomponents using the regression model based on the determined length for the subcomponent.

In other features, the control module is configured to, in response to not detecting the junction in the line component, generate a plurality of line points for the line component using the regression model and create a line based on the plurality of line points for the line component.

A method for creating a map of a roadway, includes receiving a multi-layer probability density bitmap including a plurality of pixels representing a plurality of lane lines of the roadway sensed by one or more sensors of a plurality of vehicles, extracting a plurality of line components of the plurality of lane lines, detecting whether a junction exists in a line component of the plurality of line components, in response to detecting the junction in the line component, splitting the line component into two or more subcomponents, generating a plurality of line points for each of the subcomponents using a regression model, creating at least one line based on the plurality of line points, and generating a map of the roadway including the at least one line.

In other features, the method further includes identifying connected components of the plurality of lane lines in the bitmap and categorizing each connected component as a line component of the plurality of line components.

In other features, extracting the plurality of line components of the plurality of lane lines includes implementing a plurality of masks to extract the plurality of line components.

In other features, the method further includes skeletonizing each line component of the plurality of line components to generate a skeletonized image.

In other features, detecting whether the junction exists in the line component includes detecting the junction based on the skeletonized image.

In other features, detecting the junction based on the skeletonized image includes scanning, with a kernel, the skeletonized image, calculating a value associated with the kernel, and comparing the value to a threshold to detect the junction in the line component.

In other features, the method further includes, in response to detecting the junction in the line component, removing a junction point representing the detected junction in the line component to create a plurality of vectors.

In other features, splitting the line component into two or more subcomponents includes determining an angle between each pair of the plurality of vectors, and clustering one or more pairs of the plurality of vectors based on the angle and a defined threshold to split the component into the two or more subcomponents.

In other features, generating the plurality of line points for each of the subcomponents includes determining a length of each of the subcomponents, and generating the plurality of line points for each of the subcomponents using the regression model based on the determined length for the subcomponent.

In other features, the regression model includes a B-spline regression model.

A non-transitory computer-readable medium storing instructions that, when executed by a control module, cause the control module to extract a plurality of line components of a plurality of lane lines in a multi-layer probability density bitmap, detect whether a junction exists in a line component of the plurality of line components, in response to detecting the junction in the line component, split the line component into two or more subcomponents, generate a plurality of line points for each of the subcomponents using a regression model, create at least one line based on the plurality of line points, and generate a map of a roadway including the at least one line.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example system for lane line map construction using probability density bitmaps, according to the present disclosure;

FIG. 2 is a side view of a vehicle including sensors, according to the present disclosure;

FIG. 3 is a schematic diagram of observed lane lines from vehicles on a roadway and a map of the roadway created by the system of FIG. 1, according to the present disclosure;

FIGS. 4-5 are flowcharts of example methods for creating lane line maps using probability density bitmaps, according to the present disclosure;

FIG. 6 is a flowchart of an example method for splitting a line component having a detected junction, according to the present disclosure;

FIG. 7 is a schematic diagram of a method of extracting a line component and skeletonizing the extracted line component, according to the present disclosure;

FIG. 8 is a schematic diagram of an example kernel having a 3×3 configuration, according to the present disclosure; and

FIG. 9 is a schematic diagram of a method for splitting a line component having a detected junction, according to the present disclosure;

In the drawings, reference numbers may be reused to identify similar and/or identical elements.

### DETAILED DESCRIPTION

Roadway maps may be created based on received crowd-sourced data from vehicles. For example, sensor data, such as GPS data, detected lane line data, speed data, yaw data, etc. from vehicles may be collected and processed. Then, algorithms may be employed to generate lane lines and other map content for a roadway map based on the vehicle sensor data. However, in such examples, GPS positions of an individual vehicle are not consistently accurate due to GPS errors, including errors caused by gravitational effects, solar radiation, timing inaccuracies in satellite clocks and/or receive clocks, etc. Additionally, detected lane line data across multiple vehicle passes may not be consistent due to camera obstructions, perception errors, and/or other limitations. Further, conventional algorithms to generate lane lines and other map content are inefficient (e.g., slow processing speed, inaccurate, etc.).

As one example, multiple vehicles may be travelling in the same lane (e.g., a left lane) of a roadway and provide vehicle sensor data for generating lane lines of a map. However, due to GPS errors, the GPS trajectories of the vehicles may look like the vehicles are in different lanes. Additionally, due to perception errors associated with the detected lane line data, detected lanes could be reported as erroneous types, detected lane line types for an edge of the lane (e.g., a right-side lane line) may be different (e.g., a dashed lane line, a solid lane line, etc.), detected lane line color may be inconsistent (e.g., some passes report a white color while other passes report a yellow color), etc. This leads to difficulties with aligning the geometries and related attributes of the collected crowd-sourced data into a representative outcome.

The systems and methods according to the present disclosure provide solutions for creating roadway maps by leveraging crowd-sourced vehicle sensor data and bitmaps to construct lane lines. For example, lane lines may be constructed through received multi-layer probability density bitmaps representing aggregated lane line data, lane line clustering based on processing of the multi-layer probability density bitmaps, and regression analysis for each separated lane line. With this approach, the lane lines may be constructed accurately and faster than conventional lane line construction approaches. For example, by employing the systems and methods herein, lane lines may be constructed around four times faster than conventional approaches, while maintaining and in some cases increasing accuracy of the constructed lane lines.

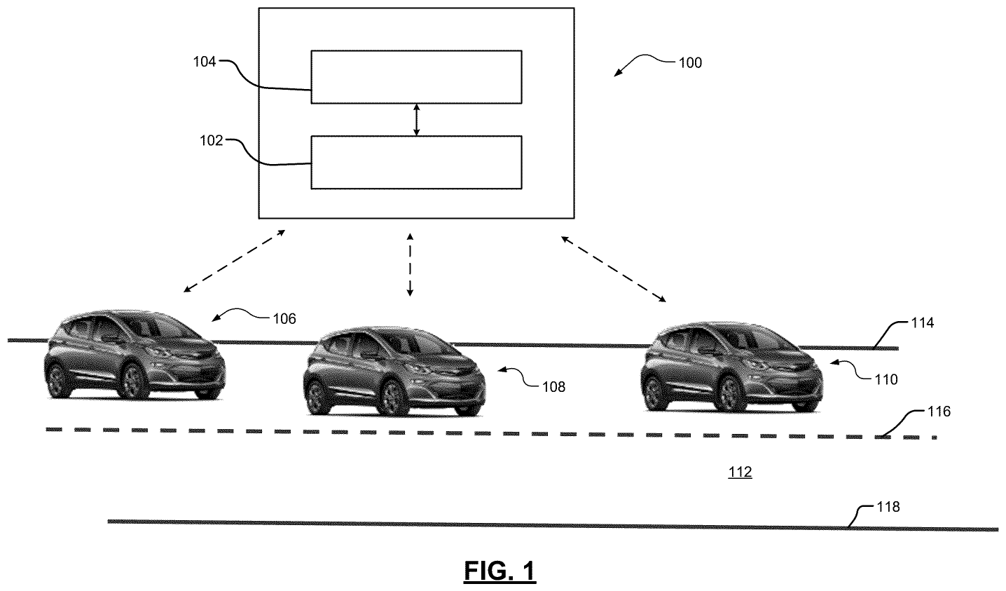

Referring now to FIG. 1, a block diagram of an example system 100 is presented for creating a map of a roadway. In the example of FIG. 1, the system 100 may be a cloud-based system and generally includes a control module 102 (e.g., a system control module) and a memory circuit 104. As shown in FIG. 1, the control module 102 is generally in communication with multiple vehicles 106, 108, 110. For example, the control module 102 may be in wireless communication with sensors in each vehicle 106, 108, 110 and/or an intervening control module in each vehicle 106, 108, 110. While FIG. 1 shows the system 100 as including three vehicles 106, 108, 110 in communication with the control module 102, it should be appreciated that the control module 102 may be in communication with more vehicles, such as thousands of vehicles.

In the example of FIG. 1, the control module 102 receives crowd-sourced data from the vehicles 106, 108, 110 on a roadway 112 having lane lines 114, 116, 118. In such examples, the vehicle sensors may collect information and generate sensor data indicative of the collected information, and then transmit the data to the control module 102. As further explained herein, the control module 102 creates lane lines representing the lane lines 114, 116, 118 for the roadway 112 and generates a map of the roadway 112 with the created lane lines.

In various embodiments, the vehicles 106, 108, 110 and/or any other vehicle in communication with the control module 102 of FIG. 1 may be any suitable vehicle, such as an electric vehicle (e.g., a pure electric vehicle, a plug-in hybrid electric vehicle, etc.), an internal combustion engine vehicle, etc. Additionally, the vehicles may be autonomous vehicles, semi-autonomous vehicles, etc. As examples only, the vehicles 106, 108, 110 may be trucks, sedans, coupes, sport utility vehicles (SUVs), recreational vehicles (RVs), etc.

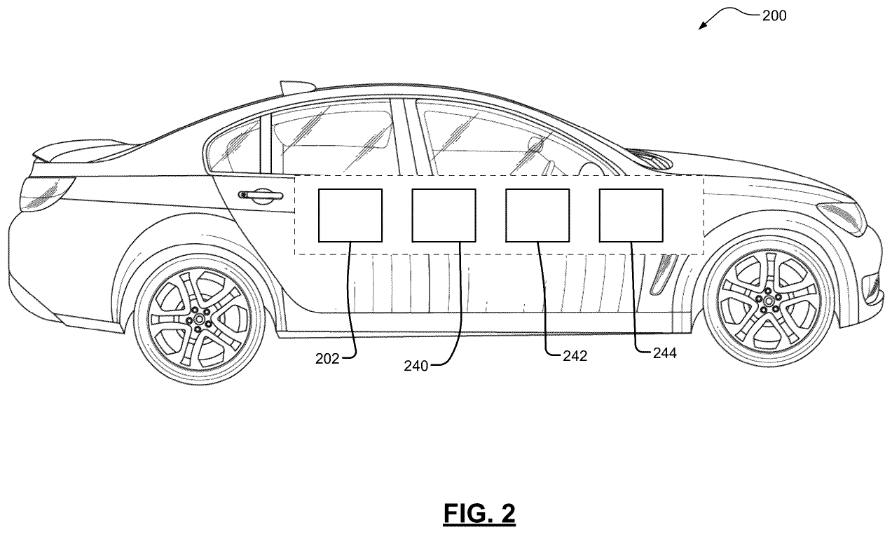

For example, FIG. 2 depicts a vehicle 200 that may represent any one of the vehicles 106, 108, 110 of FIG. 1. As shown in FIG. 2, the vehicle 200 includes a control module 202, a display module 240, and sensors 242, 244. While FIG. 2 shows the vehicle 200 as including two sensors 242, 244, it should be appreciated that the vehicle 200 (or any other vehicle herein) may include more than two sensors.

In the example of FIG. 2, the sensors 242, 244 may be in wireless communication with the control module 102 of FIG. 1 (e.g., directly and/or via the control module 202). The sensors 242, 244 generally collect information and generate sensor data indicative of the collected information. The sensors 242, 244 may include, for example, GPS transceivers, yaw sensors, speed sensors, cameras, etc. In such examples, the GPS transceivers detect the vehicle location, the speed sensors detect the vehicle speed, the yaw sensors determine the vehicle heading, and the cameras capture images of a roadway (e.g., the roadway 112 of FIG. 1) relative to the vehicle (e.g., in front of, behind, etc. the vehicle). More specifically, the cameras may capture images of the lane lines 114, 116, 118 of the roadway 112, and the control module 202 (and/or the control module 102 of FIG. 1) may detect the lane lines 114, 116, 118 based in part on the captured images and/or other sensor data.

In the example of FIG. 2, the display module 240 may be a device in communication with the control module 202. In such examples, the display module 240 may receive data from the control module 202 and/or output data to the control module 202. For instance, the display module 240 may display a roadway map generated by the control module 202 (and/or the control module 102 of FIG. 1) and viewable by a user (e.g., a driver, a passenger, etc.) in the vehicle 200.

With reference to FIGS. 1-2, the control module 102 may receive the sensor data (e.g., sensed lane line data and vehicle GPS data) from the vehicles 106, 108, 110. For instance, the sensors (e.g., the sensors 242, 244 of FIG. 2) of the vehicles 106, 108, 110 may transmit the sensor data to the control module 102 via one or more transceivers. The sensor data may include, for example, GPS data and lane line data. In such examples, the GPS data is indicative of the location of its corresponding vehicle 106, 108, 110. Additionally, the lane line data may include lane line geometry data and lane line attribute data detected by one or more cameras of the vehicles 106, 108, 110. In some examples, the lane line data may correspond to lane lines in the form of polynomial curves. In this example, the lane lines may be processed data (e.g., polynomial curves). In various embodiments, the lane line data may include information about the lane lines 114, 116, 118 observed by the one or more cameras, such as lane line color, lane line type (e.g., a solid line, a broken line, etc.), geometry of the lane line, etc.

The control module 102 constructs a lane line map using probability density bitmaps. For example, and as further explained herein, the control module 102 leverages received crowd-sourced vehicle sensor data to create bitmaps with the lane lines 114, 116, 118. Then, the control module 102 generates and outputs a roadway map including details about the lane lines 114, 116, 118 of the roadway 112. In various embodiments, the roadway map may be a high-definition (HD) map that includes precise details (e.g., details at a centimeter level) and useable in autonomous driving applications.

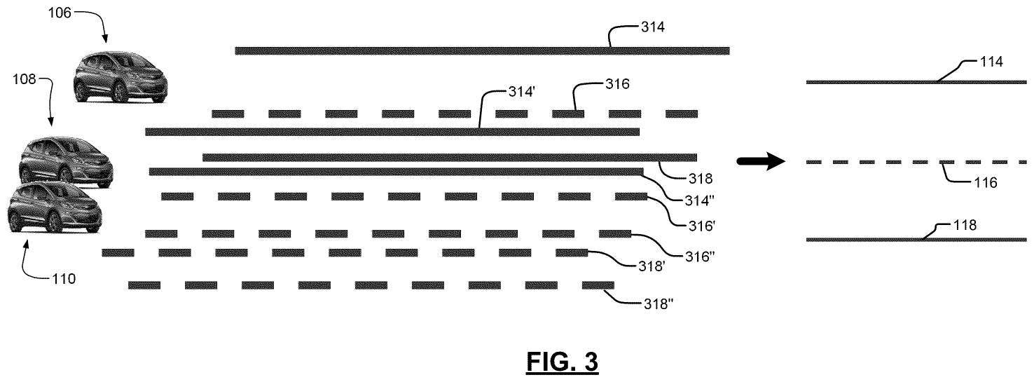

For example, the vehicles 106, 108, 110 may be on the same lane of the roadway 112, as shown in FIG. 1. However, due to errors, the sensor data from the vehicles 106, 108, 110 may be perceived to indicate that the vehicles 106, 108, 110 are traveling along different lanes and/or of lanes with different lane line types. For example, FIG. 3 depicts the vehicles 106, 108, 110 of FIG. 1 on the same lane of the roadway 112 (e.g., between lane lines 114, 116) but where their sensor data indicates that the vehicles 106, 108, 110 are on different lanes and/or on lanes with different lane line types. Specifically, although the vehicles 106, 108, 110 are on the same lane, the sensor data of the vehicles 106, 108, 110 indicates the vehicle 106 is in a lane between lane lines 314, 316, the vehicle 108 is in a lane between lane lines 314′, 316′, and the vehicle 110 is in a lane between lane lines 314″, 316″. Additionally, the sensor data of the vehicles 106, 108, 110 indicate that the lane lines 318, 318′, 318″ (which correspond to lane line 118 of FIG. 1) are of different types (e.g., a dashed lane line, a solid lane line, etc.). As further explained herein, the control module 102 uses bitmaps corresponding to the vehicle sensor data (indicating the differing lane lines of FIG. 3) to construct the lane lines 114, 116, 118, as shown in FIG. 3.

In various embodiments, the control module 102 of FIG. 1 may be programmed to execute instructions, such as any one or more of the methods described herein. In such examples, the memory circuit 104 of FIG. 1 and/or another suitable computer-readable medium may store the instructions for execution by the control module 102.

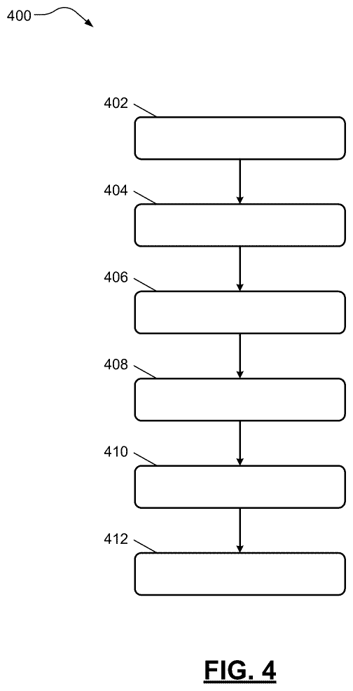

FIGS. 4-6 illustrate example methods 400, 500, 600 employable by the system 100 of FIG. 1. Specifically, and as further explained below, the methods 400, 500, 600 of FIGS. 4-6 relate to creating or otherwise construction lane lines using probability density bitmaps, and generating maps (e.g., HD maps, etc.) with the constructed lane lines. Although the example methods 400, 500, 600 are described in relation to the system 100 of FIG. 1 including the control module 102, any one of the methods 400, 500, 600 may be employable by another suitable system.

As shown in FIG. 4, the method 400 begins at 402, where the control module 102 receives crowdsourced sensor data from the vehicles 106, 108, 110 (among other vehicles) about lane lines of a roadway (e.g., the lane lines 114, 116, 118 of the roadway 112). As explained above, the sensor data may be obtained by sensors (e.g., the sensors 242, 244 of FIG. 2) of the vehicles 106, 108, 110. In such examples, the sensor data may include GPS data, lane line data, etc. The method 400 then proceeds to 404.

At 404, the control module 102 executes a GPS bias correction process. For example, the GPS data received from any one or more of the vehicles 106, 108, 110 may include GPS bias specific to a GPS transceiver in the vehicle. In such examples, the control module 102 may correct or otherwise account for any basis associated with the GPS transceiver of the vehicle 106, 108, 110 providing the GPS data. The method 400 then proceeds to 406.

At 406, the control module 102 executes a GPS random noise reduction process. In such examples, the control module 102 may reduce noise from the GPS transceiver (e.g., one of the sensors 242, 244 of FIG. 2) via one or more filters. The method 400 then proceeds to 408.

At 408, the control module 102 receives a bitmap-based lane line map using the received sensor data from the vehicles 106, 108, 110. For example, the control module 102 may rely on the received sensor data, such as the GPS data, the lane line data, heading data, and speed data of the vehicles 106, 108, 110 to create the bitmap-based lane line map. In such examples, the control module 102 may create multiple multi-layer bitmaps for each of the vehicles 106, 108, 110 using the sensor data. Then, the control module 102 may aggregate or fuse the multi-layer bitmaps of each vehicle 106, 108, 110 to create a multi-layer probability density bitmap to represent the observed lane lines of the roadway. With this configuration, the created bitmap includes multiple pixels representing the observed lane lines of the roadway. The method 400 then proceeds to 410.

At 410, the control module 102 executes a process to create or otherwise construct lane lines using the received multi-layer probability density bitmap. For example, and as further explained below, the control module 102 may detect candidate pixels in the multi-layer probability density bitmap representing junctions in a line component of the bitmap, split the line component into two or more subcomponents, generate lane line points for each of the subcomponents using a regression model, and then create a lane line based on the lane line points. The method 400 then proceeds to 412.

At 412, the control module 102 may generate and output a map of a roadway (e.g., the roadway 112 of FIG. 1). In such examples, the roadway map includes the created lane line which may represent one of the lane lines 114, 116, 118 for the roadway 112. In various embodiments, the control module 102 may transmit the map to a control module of a vehicle, such as the control module 202 of the vehicle 200 of FIG. 2. The control module 202 may then command the display module 240 to display the roadway map, and/or autonomously control movement of the vehicle 200 based on the roadway map.

As shown in FIG. 5, the method 500 begins at 502, the control module 102 receives or otherwise constructs a multi-layer probability density bitmap based on received sensor data from the vehicles 106, 108, 110. The method 500 then proceeds to 504.

At 504, the control module 102 may detect edges of lane lines in the bitmap or other locations of the lane lines. For example, the control module 102 may initially filter noise of the bitmap (e.g., a kernel density estimation (kde) image) by using a global brightness threshold. Then, the control module 102 may detect edges of the lane lines or another location of the lane lines, such as a middle portion of the lane lines. In such examples, a gradient-based kernel or a Gaussian-like kernel may be implemented to scan the bitmap to detect edges of the lane lines. In other examples, a customized kernel may be implemented to scan the bitmap to detect a middle portion of the lane lines. In such examples, a 5×5 kernel may move along the bitmap scanning pixels to detect the middle portion. The kernel includes values (e.g., brightness values) to indicate a middle portion of a lane line. For example, a large value may indicate a brighter pixel representing a middle portion of the lane line, whereas a small value (e.g., zero) may indicate a dimmer pixel (or a black pixel) representing an outer portion of the lane line (or an area not part of the lane line). The method 500 then proceeds to 506.

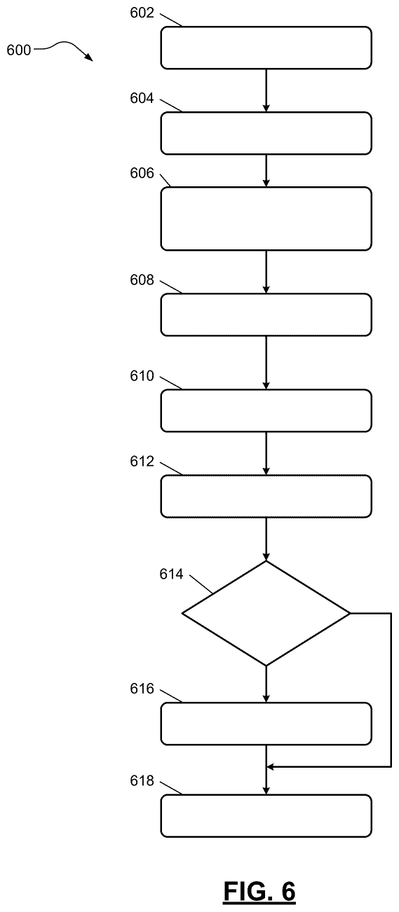

At 506, the control module 102 may identify and categorize lane lines as different line components in the bitmap. For example, the control module 102 may first identify any connected components in the bitmap, and then categorize each set of connected components and each non-connected component as different line components in the bitmap. As one example, FIG. 7 depicts a process 700 including steps 702, 704, 706. At step 702, multiple observed lane lines 708, 710, 712, 714, 716, 718, 720 of a bitmap are shown. In this example, the control module 102 identifies only the observed lane lines 718, 720 as being connected components. Then, the control module 102 categorizes the connected lane lines 718, 720 (e.g., connected components) as an individual line component 722, and categorizes the remaining other non-connected lane lines 708, 710, 712, 714, 716 as individual line components. The method 500 then proceeds to 508.

At 508, the control module 102 extracts each line component based on its categorization. For example, the control module 102 may implement different masks to extract the different line components. In such examples, a mask layer may be used with the bitmap to isolate one of the line components. This may occur for each categorized line component in the bitmap. For instance, and with continued reference to FIG. 7, a mask is applied in step 704 to isolate the categorized line component 722 (with the observed lane lines 718, 720). The method 500 then proceeds to 510.

At 510, the control module 102 skeletonizes each extracted line component to generate a skeletonized image. In such examples, each line component is represented by a single pixel wide representation following the skeletonization of that line component. For example, and with continued reference to FIG. 7, the line component 722 of step 704 is skeletonized in step 706 to generate a single pixel wide representation, as shown by a skeletonized line component 722′. The method 500 then proceeds to 512.

At 512, the control module 102 detects whether a junction exists in each extracted line component. In various embodiments, the control module 102 detects the presence of a junction (e.g., an intersection of two or more observed lane lines) in the extracted line component based on the skeletonized image of that line component. In such examples, the junction may represent one lane merging into another lane. If a junction is detected, the method 500 then proceeds to 514. Otherwise, if no junction is detected, the method 500 then proceeds to 516.

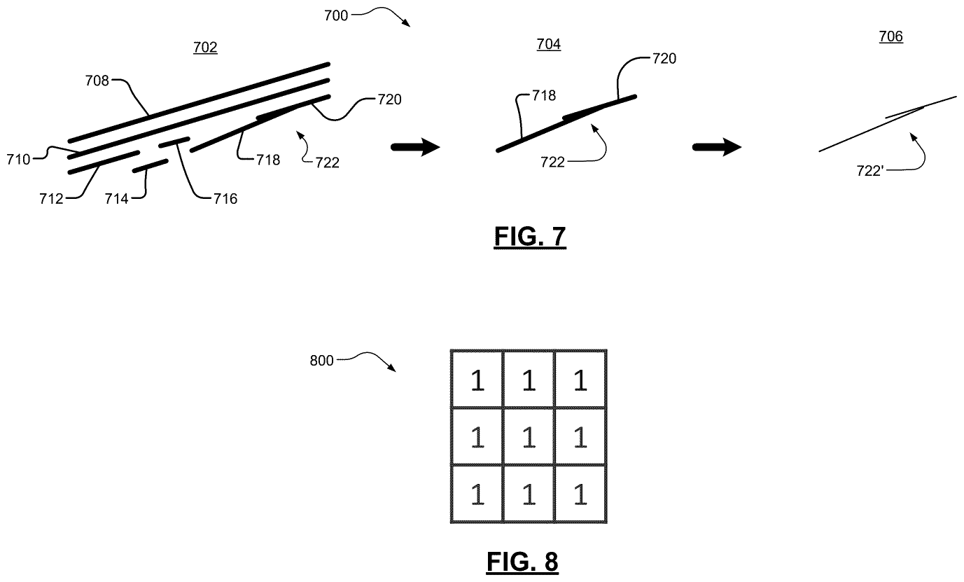

In various embodiments, the control module 102 may detect a junction in any suitable manner. For example, the control module 102 may scan the skeletonized image of an extracted line component, such as the skeletonized line component 722′ of FIG. 7. In such examples, a kernel may be implemented to scan the skeletonized image. With this configuration, the kernel may be a 3×3 kernel having all ones (e.g., each value in the kernel is one). FIG. 8 depicts one example kernel 800 having a 3×3 configuration with all ones. Then, as the kernel moves about the skeletonized image, values are determined. For example, a black pixel in the skeletonized image may be zero and a non-black pixel in the skeletonized image may be one. In such examples, when the kernel with all ones passes over a block of pixels in the skeletonized image, the kernel value (1) is multiplied by the pixel value (0 or 1). Then, the control module 102 determines a total value associated with the kernel at that point on the skeletonized image by calculating the sum of the multiplied values. The control module 102 then compares the total value to a threshold to detect the junction in the extracted line component. For example, if the total value is greater than or equal to the threshold (e.g., 3, etc.), the control module 102 detects the presence of a junction in the extracted line component. In such examples, the location of the detected junction may be saved if desired. Otherwise, if the total value is less than the threshold, the control module 102 does not detect a junction.

At 514, the control module 102 splits the line component having the detected junction into two or more subcomponents. As further explained below, the splitting of the line component may be accomplished through the removal of a junction point representing the detected junction in the line component. Once the line component is split, the method 500 then proceeds to 516.

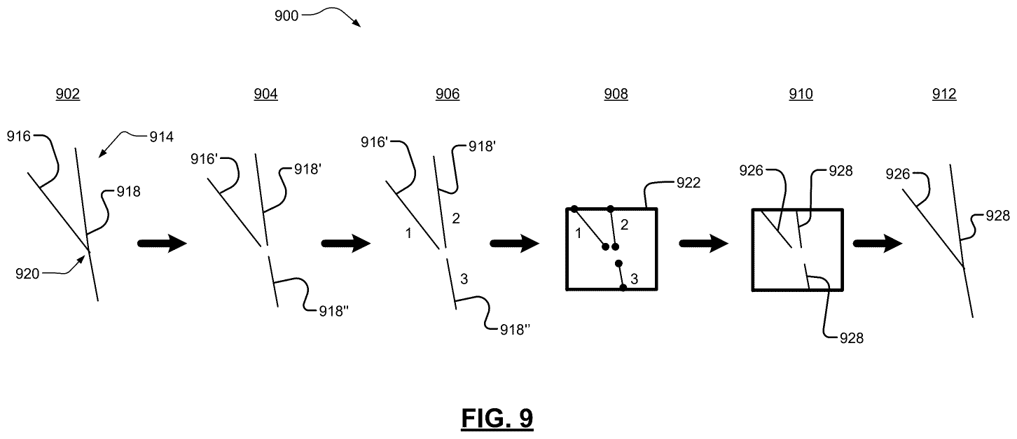

In various embodiments, the control module 102 may employ a dilation process before proceeding to 516. For instance, the control module 102 may use dilation on the skeletonized lines of extracted line components (e.g., line component having no detected junctions and the subcomponents resulting from detected junctions). Then, the control module 102 may utilize a resulting dilated image to extract the original lane line from the bitmap. One example with respect each grouped line component (having subcomponents), the control module 102 may use a mask to extract one subcomponent (e.g., subcomponent 926 of FIG. 9 explained below), implement dilation on that extracted subcomponent, and then use the resulting dilated image and the original received bitmap to extract its corresponding lane line.

At 516, the control module 102 implements a regression model to generate line points for each of the subcomponents of any line component having a detected junction and for each line component having no detected junction. In various embodiments, the control module 102 may employ a B-spline regression model and/or another suitable regression model to interpolate smooth lane line curve from candidate pixels. As one example, the control module 102 may find peaks in a signal to obtain the highest brightness points (e.g., pixels) on each subcomponent of the bitmap image. Then, the control module 102 may determine the length of that subcomponent and generate interpolate points with the regression model based on the length of the subcomponent. The control module 102 may implement the same functions (e.g., identify the highest brightness, determine the length, and generate interpolate points) for each line component having no detected junction. The method 500 then proceeds to 518.

At 518, the control module 102 creates new lane lines based on the generated line points for the subcomponents and line components. Then, the method 500 proceeds to 520, where the control module 102 may generate and output a map of a roadway (e.g., the roadway 112 of FIG. 1) including the new lane lines. In such examples, the control module 102 may transmit the map to a control module of a vehicle for display and/or control purposes, as explained above.

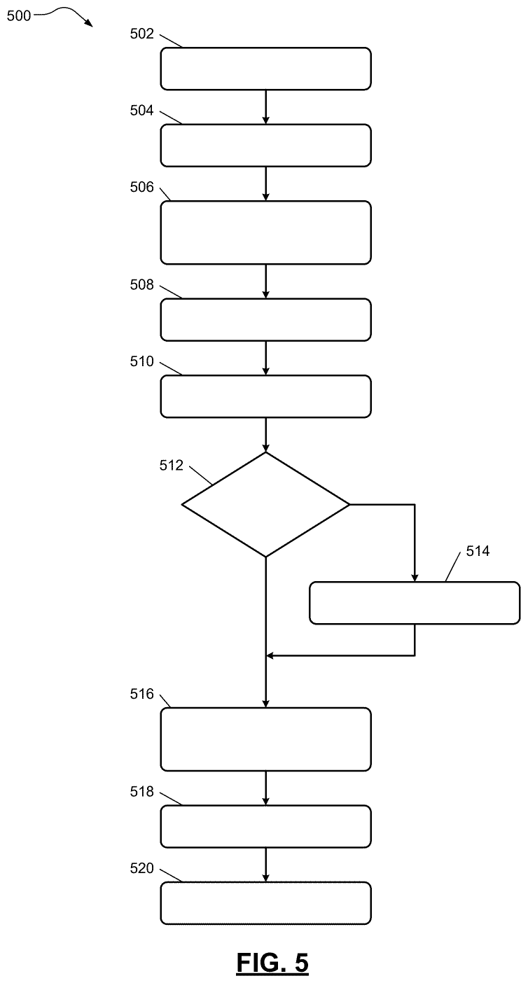

The method 600 of FIG. 6 depicts one example of splitting a line component having a detected junction into two or more subcomponents, as described herein. As shown in FIG. 6, the method 600 begins at 602, where the control module 102 detects the presence of a junction in the extracted line component (e.g., where two or more observed lane lines intersect), as explained above. For example, FIG. 9 depicts a process 900 including steps 902, 904, 906, 908, 910, 912 for splitting a line component. At step 902, two observed lane lines 916, 918 are shown as being connected components and categorized as an individual line component 914, as explained above. In this example, the lane lines 916, 918 are connected at a junction point 920 (e.g., the detected junction of line component 914). The method 600 of FIG. 6 then proceeds to 604.

At 604, the control module 102 removes a junction point representing the detected junction in the line component. In doing so, multiple vectors are created or formed with the line component. For example, and with continued reference to FIG. 9, the junction point 920 (of step 902) is removed at step 904, thereby creating vectors 916′ from the observed lane line 916 and vectors 918′, 918″ from the observed lane 918. The method 600 of FIG. 6 then proceeds to 606, 608.

At 606, the control module 102 identifies and categorizes each vector associated with the removed junction point to split the vectors into different components. In such examples, each vector may be labeled as a different component. At 608, the control module 102 selects an area around the removed junction point. In various embodiments, the area may be a small rectangle (e.g., a 12-pixel by 12-pixel area, etc.). For example, and with continued reference to FIG. 9, the vectors 916′, 918′, 918″ are categorized as components 1, 2, 3, respectively, at step 906. Then, at step 908, an area around the removed junction point is enclosed by a rectangle 922. The method 600 of FIG. 6 then proceeds to 610, 612.

At 610, the control module 102 determines end points for each component in the selected area. For instance, one end point for each component (e.g., each categorized vector) may be at an intersection of the component and a rectangle representing the selected area, and the other end point for each component may be at the end of the component near the removed junction point. Additionally, in some examples, the control module 102 may determine the vector direction based on the determined end points. As shown in FIG. 9, each component 1, 2, 3 (e.g., each categorized vector) is shown as having end points at step 908.

At 612, the control module 102 determines an angle between each pair of components (e.g., each pair of categorized vectors). For instance, at step 908 of FIG. 9, the control module 102 may determine an angle between components 1, 2, an angle between components 1, 3, and an angle between components 2, 3. The method 600 of FIG. 6 then proceeds to 614.

At 614, the control module 102 compares the determined angle between each pair of components and a defined threshold. In various embodiments, the defined threshold may be any suitable value, such as 5 degrees, 7 degrees, 10 degrees, 12 degrees, 15 degrees, etc. If the determined angle is less than the defined threshold, the method 600 of FIG. 6 proceeds to 616. Otherwise, if the determined angle is greater than or equal to the defined threshold, the method 600 of FIG. 6 proceeds to 618.

At 616, if the determined angle between a pair of components is less than the defined threshold, the control module 102 clusters that pair of components (e.g., that pair of categorized vectors) together. In doing so, the pair of components are treated as the same lane line. For example, and with continued reference to FIG. 9, the angle between components 1, 2 at 908 may be about 30 degrees and larger than a defined threshold (e.g., 10 degrees, etc.), the angle between components 1, 3 at 908 may be about 30 degrees and larger than the defined threshold (e.g., 10 degrees, etc.), and the angle between components 2, 3 at 908 may be about 5 degrees and less than the defined threshold (e.g., 10 degrees, etc.). In such examples, the components 2, 3 are clustered together and treated as the same lane line. The method 600 of FIG. 6 then proceeds to 618.

At 618, the control module 102 splits the extracted line component having the detected junction into subcomponents. For example, the control module 102 may categorize each grouping of components, thereby creating the subcomponents. In such examples, each set of components that are clustered together may be categorized as one subcomponent, and each component not meeting the clustering requirements may be categorized as another subcomponent. For instance, in FIG. 9, the component 1 is categorized as a subcomponent 926, and the components 2, 3 are clustered together and categorized collectively as a subcomponent 928. One example, the control module 102 may ascertain the corresponding components in a generated skeletonized image as explained above relative to 510 of FIG. 5. Once the corresponding components are found, the control module 102 may split the components into different lane lines. For example, at step 912 in FIG. 9, the control module 102 locates the components in a generated skeletonized image corresponding to the subcomponents 926, 928, and treats the component corresponding to the subcomponent 926 as one lane line and the components corresponding to the subcomponent 928 as another lane line.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for creating a map of a roadway, the system comprising:
a control module in communication with one or more sensors of a plurality of vehicles, the control module configured to:
receive a multi-layer probability density bitmap including a plurality of pixels representing a plurality of lane lines of the roadway sensed by the one or more sensors of the plurality of vehicles;
extract a plurality of line components of the plurality of lane lines;
detect whether a junction exists in a line component of the plurality of line components;
in response to detecting the junction in the line component, split the line component into two or more subcomponents;
generate a plurality of line points for each of the subcomponents using a regression model;
create at least one line based on the plurality of line points; and
generate a map of the roadway including the at least one line.

2. The system of claim 1, wherein the control module is configured to:
identify connected components of the plurality of lane lines in the bitmap; and
categorize each connected component as a line component of the plurality of line components.

3. The system of claim 2, wherein the control module is configured to implement a plurality of masks to extract the plurality of line components.

4. The system of claim 1, wherein the control module is configured to:
skeletonize each line component of the plurality of line components to generate a skeletonized image; and
detect the junction based on the skeletonized image.

5. The system of claim 4, wherein the control module is configured to:
scan, with a kernel, the skeletonized image;
determine a value associated with the kernel; and
compare the value to a threshold to detect the junction in the line component.

6. The system of claim 1, wherein the control module is configured to remove a junction point representing the detected junction in the line component to create a plurality of vectors in response to detecting the junction in the line component.

7. The system of claim 6, wherein the control module is configured to:
determine an angle between each pair of the plurality of vectors; and
cluster one or more pairs of the plurality of vectors based on the angle and a defined threshold to split the component into the two or more subcomponents.

8. The system of claim 1, wherein the regression model includes a B-spline regression model.

9. The system of claim 1, wherein the control module is configured to:
determine a length of each of the subcomponents; and
generate the plurality of line points for each of the subcomponents using the regression model based on the determined length for the subcomponent.

10. The system of claim 1, wherein the control module is configured to, in response to not detecting the junction in the line component, generate a plurality of line points for the line component using the regression model and create a line based on the plurality of line points for the line component.

11. A method for creating a map of a roadway, comprising:
receiving a multi-layer probability density bitmap including a plurality of pixels representing a plurality of lane lines of the roadway sensed by one or more sensors of a plurality of vehicles;
extracting a plurality of line components of the plurality of lane lines;
detecting whether a junction exists in a line component of the plurality of line components;
in response to detecting the junction in the line component, splitting the line component into two or more subcomponents;
generating a plurality of line points for each of the subcomponents using a regression model;
creating at least one line based on the plurality of line points; and
generating a map of the roadway including the at least one line.

12. The method of claim 11, further comprising:
identifying connected components of the plurality of lane lines in the bitmap; and
categorizing each connected component as a line component of the plurality of line components.

13. The method of claim 12, wherein extracting the plurality of line components of the plurality of lane lines includes implementing a plurality of masks to extract the plurality of line components.

14. The method of claim 12, wherein:
the method further includes skeletonizing each line component of the plurality of line components to generate a skeletonized image; and
detecting whether the junction exists in the line component includes detecting the junction based on the skeletonized image.

15. The method of claim 14, wherein detecting the junction based on the skeletonized image includes:
scanning, with a kernel, the skeletonized image;
calculating a value associated with the kernel; and
comparing the value to a threshold to detect the junction in the line component.

16. The method of claim 14, further comprising, in response to detecting the junction in the line component, removing a junction point representing the detected junction in the line component to create a plurality of vectors.

17. The method of claim 16, wherein splitting the line component into two or more subcomponents includes:
determining an angle between each pair of the plurality of vectors; and
clustering one or more pairs of the plurality of vectors based on the angle and a defined threshold to split the component into the two or more subcomponents.

18. The method of claim 17, wherein generating the plurality of line points for each of the subcomponents includes:
determining a length of each of the subcomponents; and
generating the plurality of line points for each of the subcomponents using the regression model based on the determined length for the subcomponent.

19. The method of claim 11, wherein the regression model includes a B-spline regression model.

20. A non-transitory computer-readable medium storing instructions that, when executed by a control module, cause the control module to:
extract a plurality of line components of a plurality of lane lines in a multi-layer probability density bitmap;
detect whether a junction exists in a line component of the plurality of line components;
in response to detecting the junction in the line component, split the line component into two or more subcomponents;
generate a plurality of line points for each of the subcomponents using a regression model;
create at least one line based on the plurality of line points; and
generate a map of a roadway including the at least one line.
